(19) United States
(12) Patent Application Publication
(10) Pub. No.: US 2012/0310867 A1
(43) Pub. Date: Dec. 6, 2012

(54) Method for Learning Remote Control and Learning Remote Control Thereof

(75) Inventors: Boon Chen Lim, Quarry Bay (CN); Yeung How Lim, Quarry Bay (CN)

(73) Assignee: CYBIO ELECTRONIC (SHENZHEN) COMPANY LIMITED, Shenzhen City, Guangdong (CN)

(21) Appl. No.: 13/577,902

(22) PCT Filed: Feb. 22, 2011
(86) PCT No.: PCT/CN2011/071174

§ 371 Date: Aug. 8, 2012

(30) Foreign Application Priority Data
Nov. 26, 2010 (CN) 201010561069.3

(51) Int. Cl. G06F 15/18

(52) U.S. Cl. 706/12

(57) ABSTRACT

A learning method and a learning remote control in the present invention include: selecting keys to be taught on the learning remote control, and constructing a key series; performing such operation to each key to be taught as: prompting to the keys to be taught, and then receiving and learning commands from a teaching remote control according to the key to be taught; and when being detected that a key is further selected during the operation to each key to be taught, renewing the key series according to this key, and reexecute the operation to each key. The user follows flexible and simple operating steps during the learning procedure of the learning remote control. The operation is brief, and the learning procedure is simple. The intelligent performance of the learning remote control is improved.

### FIELD OF THE INVENTION

The present invention relates to remote controlling, and especially to a learning method of a remote control and the learning remote control.

### DESCRIPTION OF RELATED ART

In nowadays, there are various and multifunctional remote controls in the market. The remote control has a built-in database for storing a large numbers of control signals to control various kinds of electrical appliances, such as TV, VCR, DVD player, and so on. However, there are various brands and models of electrical appliances in the world. Therefore, it is very difficult for a remote control with one database being able to control all kinds of electrical appliances.

Many kinds of remote controls have learning function, which is a learning remote control, can learn commands and instructions transmitted from a teaching remote control. However, the learning procedure is relatively complicate. When a key of the learning remote control is selected to be taught, the learning remote control will instruct the user to operate the corresponding key of the teaching remote control, such that the teaching remote control will transmit the commands and instructions according to the selected key of the learning remote control; and then, the learning remote control will enter into the learning procedure of a next key to be taught. During the first learning procedure, if the user presses the key of the learning remote control, then the learning procedure will interrupt. If more keys will be taught, it is necessary that after user selects the key of the learning remote control to be taught, he shall press the corresponding key of the teaching remote control to send commands and instructions to be taught. Such operation is repeated for the next key's learning procedure.

The prior learning remotes at least have such problems as: the key's learning procedure is performed via following step by step; in which, the user presses the selection key of the learning remote control, and further presses the corresponding key of the teaching remote control. Therefore, it is necessary for the user to operate many times during the learning procedure of the learning remote control. The operation is miscellaneous, and the learning procedure is complicate too.

### SUMMARY OF THE INVENTION

A main object of the present invention is to provide a learning method and a learning remote control, for which, the user follows a flexible and simple operation steps. The operation is brief, and the learning procedure is simple.

To obtain the above object, a learning method of a learning remote control in the present invention comprises:

selecting keys to be taught of the learning remote control to constitute a key series to be taught;

successively performing such operation to each key to be taught in the key series as: prompting to the key to be taught, and then receiving and learning commands and instructions from teaching remote controls according to the key to be taught;

when it is detected that a key of the learning remote control is further selected during the operation to each key to be taught in the key series, then the key series will be renewed according to the further selected key, and the operation to each key in the renewed key series is reperformed.

Furthermore, the learning remote control comprises:

keys;

memory module, for storing the key series constructed by the selected keys to be taught;

learning module, which successively performs such operation to each key in the key series to be taught as: prompting to the key to be taught, and then receiving and learning commands and instructions from the teaching remote control corresponding to the key to be taught; and

first detecting module, which detects that if a key is further selected during the operation to each key in the key series to be taught, renews the key series according to the further selected key, and initiates the learning module to reperform the operation.

The learning method and the learning remote control of the present invention at least have such advantages as follows.

The learning procedure is performed by steps of: selecting keys of the learning remote control to constitute a key series to be taught; successively performing such operation to each key in the key series as: prompting to the key to be taught, and then receiving and learning commands and instructions from the teaching remote control corresponding to the keys to be taught; and when it is detected that a key of the learning remote control is further selected during the operation to each key in the key series, then the key series will be renewed according to the further selected key, and the operation to each key in the renewed key series is reperformed. Therefore, the user follows flexible and simple operating steps during the learning procedure of the learning remote control. The operation is brief, and the learning procedure is simple. The intelligent performance of the learning remote control is improved.

### BRIEF DESCRIPTION OF THE DRAWINGS

FIG. 1 is a flow chart of a learning method of a learning remote control in accordance with an embodiment of the present invention; and

FIG. 2 is a plan view of the learning remote control in accordance with the embodiment of the present invention.

### DETAILED DESCRIPTION OF THE INVENTION

A learning method of a learning remote control according to the embodiment of the present invention mainly comprises steps of that:

(1) the learning remote control enters into a learning mode (pressing learning key of the learning remote control), keys to be taught are selected to construct a key series to be taught, then the learning remote control successively performs the same operation to each key in the key series as: automatically prompting to the key to be taught via lighting, voice, screen text, or the like; instructing to press teaching remote control to send commands according to one key to be taught, and receiving and learning the commands according to the key; in this way, after completing one key's learning procedure, automatically instructing to press teaching remote control again according to a second key for executing next key's learning procedure; and executing the operation in the same manner until arriving at the end of the whole key series to be taught;

whereby, when the learning remote control learns commands from the teaching remote control, it is not necessary to press the keys one by one on the keypad of learning remote control; namely, not necessary in such way as pressing a first key to be taught of the learning remote control and then pressing the corresponding key of the teaching remote control for sending commands to the learning remote control, after a first key's learning procedure succeeding, pressing a second key to be taught of the learning remote control and then pressing the teaching remote control again for sending commands to the learning remote control according to the second key; and

(2) during the learning remote control performs the same operation to each key in the key series to be taught, namely, at the beginning or during the teaching remote control being instructed to send commands according to the selected keys one by one, a detecting module of the learning remote control detects that more keys on a keypad thereof are further pressed in a presetting time period, which is stored in a memory module, the key series will be renewed according to the keys stored in the memory module; if no key is further pressed in a presetting time (such as 3 or 5 seconds), then the learning remote control will reperform the operation: that's, the learning remote control prompts, instructs the teaching remote control to send commands according to all the keys of the learning remote control selected and pressed one by one, and then receives the commands and follows to learn;

wherein, such way can avoid that: during the learning remote control automatically prompts and instruct the teaching remote control to send commands according to the keys to be taught one by one to the learning remote in a series of learning procedure, if more keys are further pressed, the learning procedure will be interrupted; thereafter, for more keys' learning procedure, the users have to press a key of the learning remote control and then to accordingly press teaching remote control; and after completing the first key's learning procedure, the users have to press the second key of the learning remote control, and then correspondingly press the teaching remote control again.

The key series of the learning remote control described above is factory-set, thus it is relatively complete and in a long series. The user often needs the learning remote control only to learn some usual controlling keys. According to the learning remote control of the present invention, the user can select the keys to be taught on the learning remote control' keypad once, then follow the instruction of the learning remote control, and continuously press the corresponding keys on the original remote one by one for transmitting commands for the learning remote control.

The learning method and the learning remote control of the present invention will be described in detail according to the following embodiment.

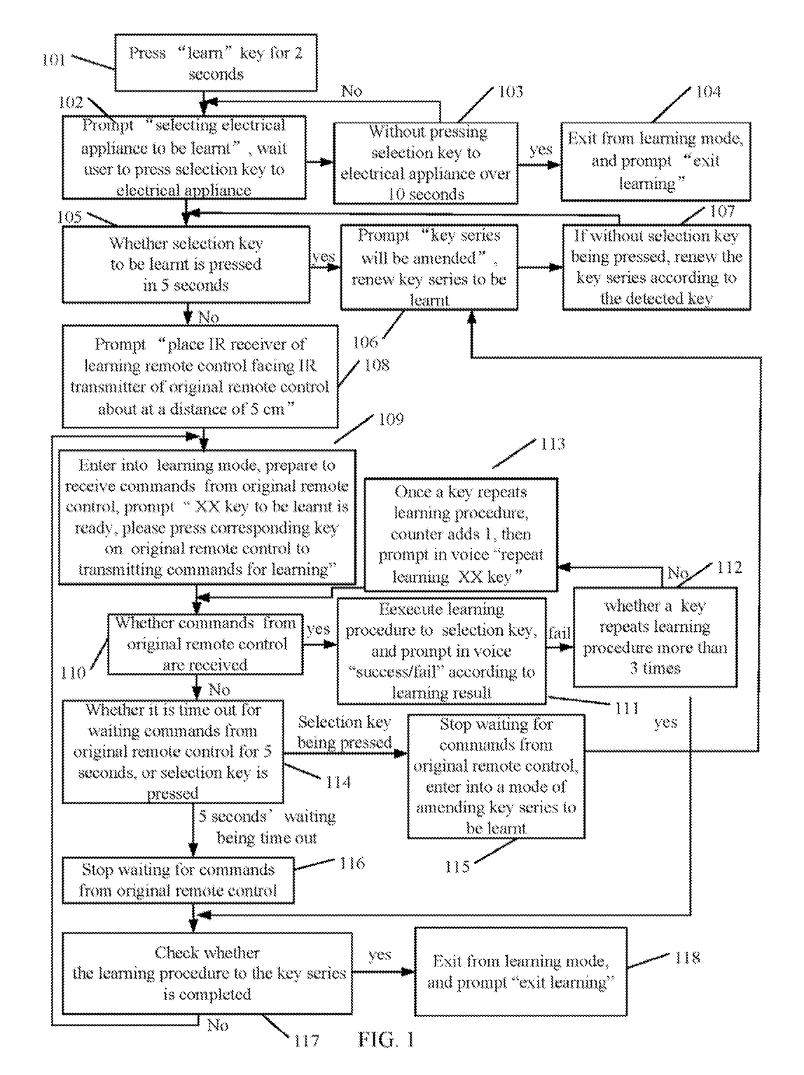

Referring to FIG. 1, a flow chart of the learning method of the learning remote control mainly comprises:

101, the users press the “learn” key on the learning remote control for 2 seconds so that the learning remote control enters into a learning mode;

102, the learning remote control prompts in voice “choosing appliance to be taught”, and waits for the user to press a selection key to the electrical appliance;

103, if the user doesn't press a selection key to the electrical appliance over 10 seconds, then execute 104;

104, the learning remote control exits from the learning mode, and prompt “exiting learning”;

105, if the user presses a selection key to the electrical appliance, then the learning remote control detects whether other key to be taught is further pressed within 5 seconds, namely, whether there are infrared key pressed;

106, if the learning remote control detects an IR key being firstly pressed, then, the IR key is renewed into the learning key series, the learning remote control prompts in voice “key series will be amended”, and the key series executes 107;

107, if without selection key being pressed, the learning remote control renews the key series to be taught according to the detected key in 106, and returns to execute 105;

108, if the learning remote control detects no IR key being pressed within 5 seconds, then prompts in voice “place IR receiver of the leaning remote control facing IR transmitter of the teaching remote control about at a distance of 5 cm”, and executes 109;

109, the learning remote control enters into a learning mode, prepares to receive commands and instructs (namely, infrared signals) from the teaching remote control, prompts in voice “XX key to be taught is ready, please press the corresponding key on the teaching remote control to transmitting commands for learning”, and executes 110;

110, the learning remote control identifies whether commands from the teaching remote control are received, if yes, then executes 111, and otherwise executes 114;

111, the learning remote control executes the learning procedure of the key, and prompts in voice “success/fail” according to the learning result;

112, if the learning result in 111 is fail, the learning remote control identifies whether a key repeats learning procedure more than 3 times, if yes, then executes 117, and otherwise, executes 113;

113, once a key repeats the learning procedure, the counter will plus 1, and the learning remote control prompts in voice “repeat learning XX key”, and returns to execute 110;

114, the learning remote control indentifies whether it is time out to wait the teaching remote control sending commands for 5 seconds at step 110, or there is selection key pressed on the learning remote control; if 5 seconds' waiting being time out, then 116 will be executed; if there is key pressed, 115 will be executed;

115, the learning remote control stops waiting for commands from the teaching remote control, enters into a mode of amending the key series to be taught, and then returns to execute 106;

116, the learning remote control stops waiting for commands from the teaching remote control, and executes 117;

117, the learning remote control checks whether the learning procedure to the key series is completed, namely, whether arrives at the end of the key series to be taught; if yes, executes 118, and otherwise returns to execute 109; and

118, the learning remote control exits from learning mode, and prompts in voice “exit learning”.

The learning method of in accordance with the embodiment of the present invention provides the user to follow flexible and simple operating steps during the learning procedure. The operation is brief, and the learning procedure is simple. The intelligent performance of the learning remote control is improved.

The learning remote control in accordance with the embodiment of the present invention comprises: keys, memory module, learning module, and a first detecting module. Keys and the first detecting module are respectively associated with the memory module, and the learning module is associated with the first detecting module.

Herein, the memory module is used for storing the key series constructed by a certain number of selection keys to be taught.

The learning module successively performs such operation to each selection key according to the key series to be taught as: prompting to the selection keys, then receiving and learning the commands from the teaching remote control according to the keys to be taught.

The first detecting module is used to detect when a key is further selected during the operation to each key according to the key series, renew the key series according to the further selected key, and then initiate the learning module to reperform the operation aforementioned.

The learning remote control is described in detail in accordance with the following embodiment.

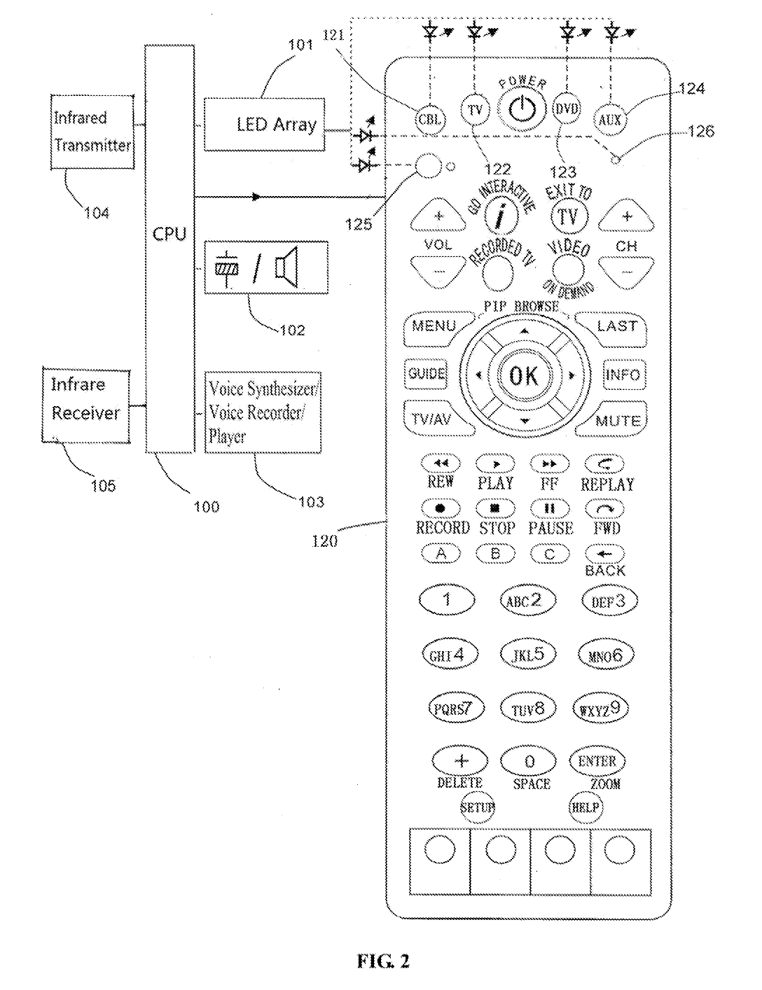

The learning remote control as shown in FIG. 2 comprises a keypad with keys set thereon, a memory module, a learning module, the first detecting module, an infrared transmitter 104, and an infrared receiver 105. The learning module comprises a CPU 100 and a prompting device. The prompting device may comprise LED array 101, voice synthesizer/voice recorder/player 103, and buzzer/speaker 102.

The keypad may comprise learning key 125, selection keys to electrical appliances 121-124, such as CBL key, TV key, DVD key, AUX key, and the indicator 126 for indicating the selection keys.

The memory module is used to store the key series constructed by the selected keys to be taught.

The learning module successively performs such operation to each key to be taught according to the key series as: prompting to the keys to be taught, and then receiving and learning commands from the teaching remote control according to the keys to be taught.

The first detecting module is used to detect when a key is further selected, renew the key series according to this selected key and initiate the learning module to reperform the aforementioned operation.

The CPU 100 is mainly used to analyze and learn the commands and instructions from the teaching remote control, control and send commands and instructions to the electrical appliance so as to implement the controlling to various kinds of electrical appliances, produce and process all kinds of inner orders of the learning remote control.

The prompt device is performed under control of the CPU 100.

The LED array 101 comprises a plurality of light emitters, which can be set under the keys, as shown in FIG. 2 as dashed lines. Each Light-Emitting Diode in the LED array 101 is respectively set under the selection keys to the electrical appliances 121-124 and the learning key 125. Furthermore, the indicator 126 is a Light-Emitting Diode as well.

It is understood that the prompting device may be a screen.

The infrared transmitter 104 and infrared receiver 105 which are respectively associated with the CPU 100, are respectively used for signal exchange between CPU 100 and electrical appliance, and for signal exchange between CPU 100 and the teaching remote control.

It is understood that all or parts of the procedures in accordance with the embodiment above, may be implemented via programs instructing corresponding hardware. Such programs can be stored in machine readable medium. When the programs execute, may include the procedure or steps of the method described above. Such readable medium maybe diskette, CD, Read-Only Memory (ROM), Random Access Memory (RAM), or the like.

While the invention has been described in conjunction with specific embodiments, it is evident that numerous alternatives, modifications, and variations will be apparent to those skilled in the art in light of the forgoing descriptions. The scope of this invention is defined only by the following claims.

What is claimed is:

1. A learning method of a learning remote control comprising:
selecting a certain number of keys to be taught on the learning remote control to construct a key series;
performing such operation to each key to be taught according to the key series as: prompting to the keys to be taught, and then receiving and learning commands from a teaching remote control according to the key to be taught; and
when it is detected that a key is further selected during the operation to each key to be taught, renewing the key series according to the further selected key, and reperforming the operation to each key to be taught according to the renewed key series.

2. The method according to claim 1, wherein prompting to the keys to be taught comprises prompting to the keys in lighting, in voice, or in screen text.

3. The method according to claim 1, wherein, when it is detected that a key is further selected during the operation to each key to be taught, renewing the key series according to the further selected key, and reperforming such operation to each key as:
if it is detected that a key is further selected during the operation to each key to be taught, renewing the key series according to the further selected key; if no key is further selected after a preset time period, and then reperforming the operation to each key to be taught.

4. A learning remote control, comprising:
keys;
a memory module, for storing a key series which is constructed by a certain number of selection keys to be taught;
a learning module, for performing such operation to each key to be taught according to the key series as: prompting to the keys to be taught, and then receiving and learning commands from a teaching remote control according to the key to be taught; and
a first detecting module, for when it is detected that a key is further selected during the operation to each key to be taught, renewing the key series according to the further selected key, and activating the learning module to reperform the operation to each key to be taught.

5. The learning remote control according to claim 4, further comprising:
an infrared transmitter for sending orders to a controlled appliance;
an infrared receiver for receiving orders; and
the learning module, comprising:
a central processing unit (CPU) for receiving and learning the commands, and for controlling to send orders to the controlled appliance; and
an indicating device for prompting under control of the CPU.

6. The learning remote control according to claim 5, wherein the indicating device comprises LED array, voice synthesizer, voice recorder, player, or screen.
